(19) United States
(12) Patent Application Publication
(10) Pub. No.: US 2020/0055069 A1
(43) Pub. Date: Feb. 20, 2020

(54) AEROSOL SPRAY GUARD

(71) Applicant: Basil Paul ANDREWS, Mississauga (CA)

(72) Inventor: Basil Paul ANDREWS, Mississauga (CA)

(21) Appl. No.: 16/610,236

(22) PCT Filed: May 4, 2018
(86) PCT No.: PCT/CA2018/050538

§ 371 Date: Nov. 1, 2019

Related U.S. Application Data
(60) Provisional application No. 62/501,259, filed on May 4, 2017.

(51) Int. Cl. B05B 12/20; B05B 12/32; B44D 2/00; F16N 31/02

(52) U.S. Cl. CPC B05B 12/20; B05B 12/32; B62M 9/00; F16N 31/02; B44D 2/007

(57) ABSTRACT

A spray guard mountable to an aerosol dispenser has a catchment tray, a mounting means and a backsplash. The catchment tray and the backsplash, together are configured for being moveable between a storage position shaped to wrappingly accommodate a curvature of the aerosol dispenser, and an in-use position wherein the backsplash extends substantially perpendicular to the longitudinal axis of the catchment tray. The spray guard may be used to capture overspray from an aerosol dispenser by placing the target object between the nozzle of the aerosol dispenser and the spray guard. Alternatively, the spray guard may be placed in front of small or awkwardly positioned items and used to narrowly focus the aerosol spray. The spray guard can feature a stencil and be used to focus an aerosol spray to transfer a stenciled image on to a substrate.

### FIELD OF THE INVENTION

The present invention relates generally to devices used to focus or direct the spray from an aerosol dispenser.

### BACKGROUND OF THE INVENTION

Aerosol dispensers provide a convenient means for dispensing a strong pressurized stream or fan spray a liquid toward a targeted coverage area. Moving the aerosol dispenser while dispensing the liquid can result in a fine layer of the liquid being applied to the entirety of a targeted item. Given their convenience of operation, aerosol dispensers are often used to apply paints, lubricants or cleaning solutions.

A fan spray provides more efficient coverage of an item than does a pressurized stream. Unfortunately, the fan spray not only hits the target object but also anything else within the coverage area of the fan spray. Thus, the fan spray creates “overspray” that soils surrounding areas and requires clean up. In some instances, users will deploy drop sheets in their work areas to absorb overspray and make clean up easier. Aerosol dispensers which dispense a pressurized stream may also create overspray, but to a lesser extent.

Overspray is particularly problematic in situations where a lubricant is the fluid dispensed from an aerosol dispenser. When an aerosol lubricant is used, a strong pressurized stream or fan spray is directed toward a target object, such as a chain to be lubricated, a mechanism or bolt needing lubricant. Since a lubricant is, by definition, slippery, the overspray of lubricant is also slippery and can soil unwanted areas like a motorcycle tire, bicycle tire or vehicle chassis parts. It is particularly dangerous for friction items such as tires or brake pads to become soiled with lubricant overspray, as these items must be clean to have a frictional grip. Getting a chain lubricant overspray onto a motorcycle tire for example, can be dangerous to the rider.

Users will often attempt to capture overspray, particularly in confined spaces, by holding a piece of cardboard or other material behind the item being sprayed to prevent the overspray from getting onto important and safety related items. With one hand holding a piece of cardboard, the user has only one hand to complete the task of dispensing the aerosol liquid. It is standard practice to have a free hand to rotate the tire which in turn rotates the chain being lubricated so that it can be completely lubricated.

Backsplash structures have been created that can be attached to an aerosol can to provide a small area of backsplash which can be positioned behind the target item to capture aerosol overspray. Typically, these structures are rigid and somewhat bulky as they need to support the backsplash at a location distally spaced from the spray nozzle of the aerosol dispenser. These constraints mean that conventional back splash structures can be rather expensive to manufacture and awkward to package for shipping and retail sale. Aerosol dispensers are disposable articles designed to hold a fairly small quantity of liquid to be dispensed for short periods of time, possibly interspersed with longer periods of non-use and storage until the liquid is again needed. Since aerosol dispensers are disposable, accessories such as backsplash structures for use with aerosol dispensers may be disposable also. Users may be unlikely to save and store an aerosol accessory after the aerosol dispenser has been emptied and discarded. Even if the accessory is retained, the user is likely to misplace the accessory before it is needed again for use with a new aerosol dispenser. These accessories should be inexpensive to manufacture, given their short lifespan. Ideally, the accessories should also be packaged for sale with the aerosol dispenser so that they are available at the time of use. Additionally, it is beneficial if the accessories can be stored on or with the aerosol dispenser during short periods of non-use.

Often times aerosol dispensers are sold as is, without additional boxes or other packaging. This allows numerous dispensers to be closely packed within a shipping carton to minimize shipping costs. Backsplash structures that are rigid and bulky are more difficult to package with an aerosol dispenser for storage and shipping. They can be packed with the aerosol dispenser into a box for sale, though this necessitates additional packaging. They can be sold separately in their own packaging. Alternatively, they can be fixed to the aerosol dispenser, but this approach requires additional retail shelf space and additional shipping container space. Moreover, rigid designs often only fit onto aerosol containers having a specific diameter. This means manufacturing multiple versions of the backsplash structures to accommodate different sizes of aerosol dispensers. All of these considerations add to the effective cost of an accessory which, given its disposable purpose, must be an relatively inexpensive item.

### SUMMARY OF THE INVENTION

A spray guard mountable to an aerosol dispenser comprises a catchment tray having a proximal end and a distal end and defining a longitudinal axis. A mounting means is positioned adjacent to the proximal end of the catchment tray and, a backsplash having a proximal end and a distal end and defining a longitudinal axis is contiguous with the distal end of the catchment tray. The catchment tray and the backsplash, together, are configured for being moveable between a storage position shaped to wrappingly accommodate a curvature of the aerosol dispenser, and an in-use position wherein the backsplash extends substantially perpendicular to the longitudinal axis of the catchment tray. The backsplash is hinged to the distal end of the catchment tray.

In a first embodiment the backsplash, the catchment tray, and the mounting means are constructed of a continuous piece of semi-pliant material defining a flexing axis between the backsplash and the catchment tray and forming a living hinge therebetween. The backsplash and the catchment tray are reversibly warpable to curve about their longitudinal axes to wrappingly accommodate the curvature of the aerosol dispenser.

In a second embodiment, the backsplash defines an opening therethrough of a selected shape and size to permit a portion of an aerosol to pass through the backsplash in a focused spray.

In a third embodiment, the backsplash is curved about its longitudinal axis to wrappingly accommodate the curvature of the aerosol dispenser. The catchment tray is curved about its longitudinal axis to wrappingly accommodate the curvature of the aerosol dispenser. The distal end of the catchment tray is attached to the proximal end of the backsplash by a hinge, and the mounting means is hinged to the proximal end of the catchment tray. In an alternative embodiment of the invention, the backsplash defines a stencil opening therethrough of a selected shape to permit a portion of an aerosol to pass through the backsplash in a focused spray to transfer an image of the selected shape onto a substrate.

### BRIEF DESCRIPTION OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown in the drawings.

FIG. 1 is a perspective view showing a spray guard mountable to an aerosol dispenser, shown in operation.

FIG. 2 is side view of a first embodiment of a spray guard in a storage position wrapped around an aerosol dispenser.

FIG. 3 is a plan view of the first embodiment.

FIG. 4 is a perspective view of the first embodiment in an in-use position.

FIG. 5 is a perspective view of the first embodiment in an in-use position and mounted on an aerosol dispenser.

FIG. 6 is a perspective view of the first embodiment in operation.

FIG. 7 is an exploded view the spray guard and an absorbent member in an in-use position.

FIG. 8 is a perspective view the spray guard and an absorbent member in an in-use position.

FIG. 9 is a plan view of a second embodiment of the spray guard.

FIG. 10 is a perspective view of the second embodiment of the spray guard shown in an in-use position mounted on an aerosol dispenser.

FIG. 11 is a perspective view of the second of the spray guard shown in operation.

FIG. 12 is a perspective view of the third embodiment of the spray guard in a storage position.

FIG. 13 is a perspective view of the third embodiment of the spray guard in a partially deployed position.

FIG. 14 is a perspective view of the third embodiment in an in-use position.

FIG. 15 is an exploded view of a variant of the third embodiment of the spray guard with an aerosol dispenser.

FIG. 16 is a perspective view of a variant of the third embodiment having an actuator mounting on the aerosol dispenser.

FIG. 17 is a perspective view of an alternative embodiment of the invention having a stencil, shown in operation.

### DETAILED DESCRIPTION OF THE INVENTION

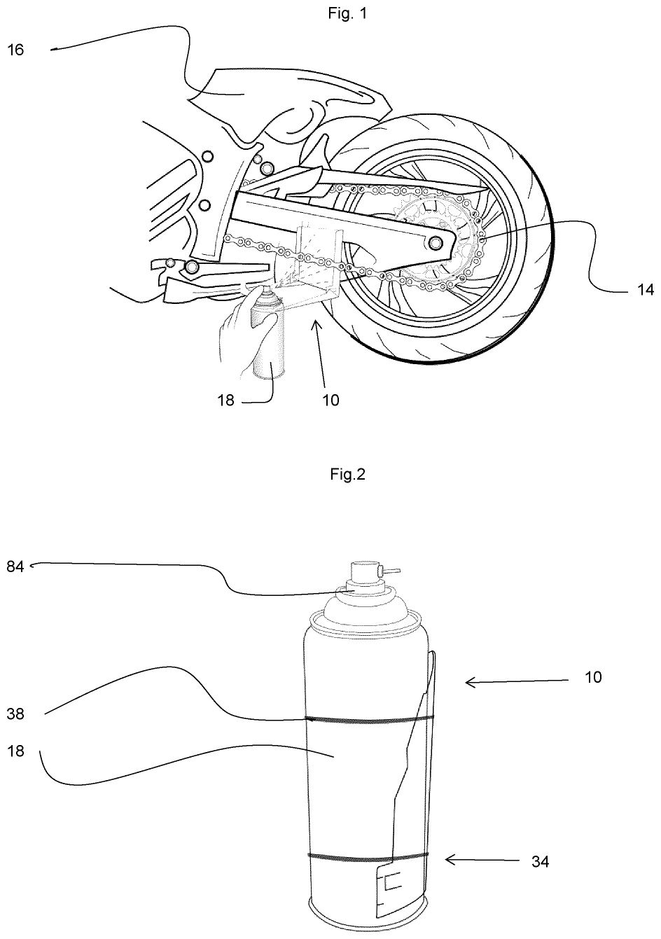

The embodiments of the present invention will now be described in detail with reference to the drawing figures. FIG. 1 shows a spray guard indicated generally by reference numeral 10. The spray guard 10 is mountable to an aerosol dispenser 18. The spray guard 10 can be seen in operation mounted to the aerosol dispenser 18 and dispensing an aerosol 12 spray (in this case a lubricant) to lubricate a chain 14 of a motorcycle 16. Although the aerosol dispenser 18 shown in the figures is an aerosol can, the various embodiments of the present invention can, with routine modification, be used with other types of aerosol dispensers, for example pump action misters.

The spray guard 10 comprises a catchment tray 20 having a having a proximal end 22 and a distal end 24 and defining a longitudinal axis. A mounting means 26 is positioned adjacent to the proximal end 22 of the catchment tray 20. A backsplash 28 has a proximal end 30 and a distal end 32 and defines a longitudinal axis. The backsplash 28 is contiguous with the distal end 22 of the catchment tray 20. The longitudinal axis of the catchment tray 20 is the same as the longitudinal axis of the backsplash 28, and the longitudinal axis through both components is represented in FIG. 3 by a dotted line 25 extending beyond the entire spray guard 10.

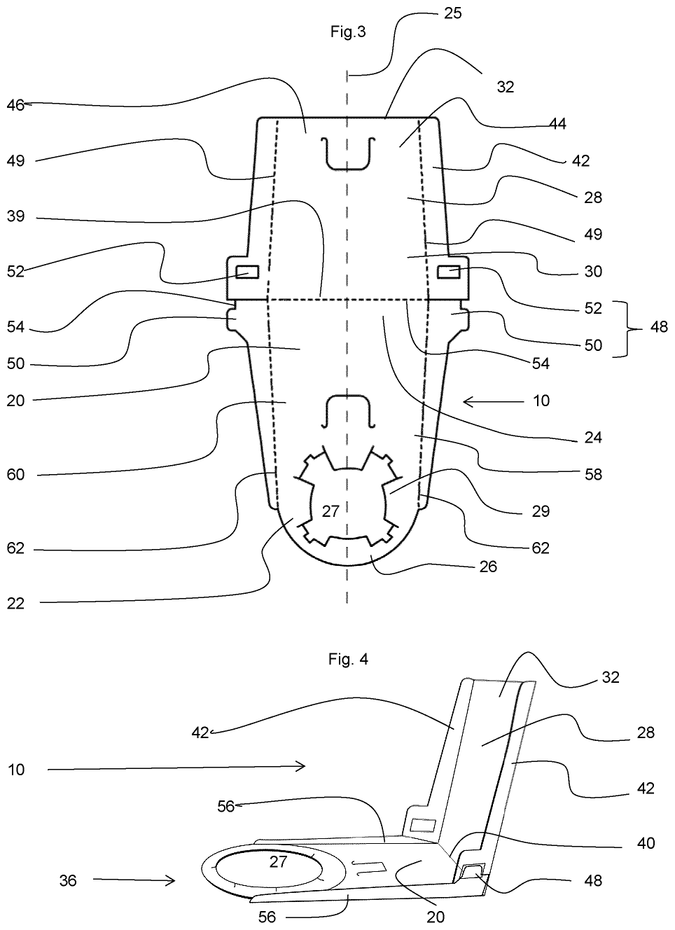

The catchment tray 20 and the backsplash 28, together, are configured for being moveable between a storage position 34 shaped to wrappingly accommodate a curvature of the aerosol dispenser 18, and an in-use position 36 wherein the backsplash 28 extends substantially perpendicular to the longitudinal axis of the catchment tray 20. The backsplash 28 is hinged to the distal end 24 of the catchment tray 20 by hinge 39. A comparison of FIG. 2 and FIG. 4 illustrates this feature according to a first and second embodiment of the present invention. As will be discussed in greater detail below, a comparison of FIGS. 12-14 illustrates this feature according to the third embodiment of the present invention.

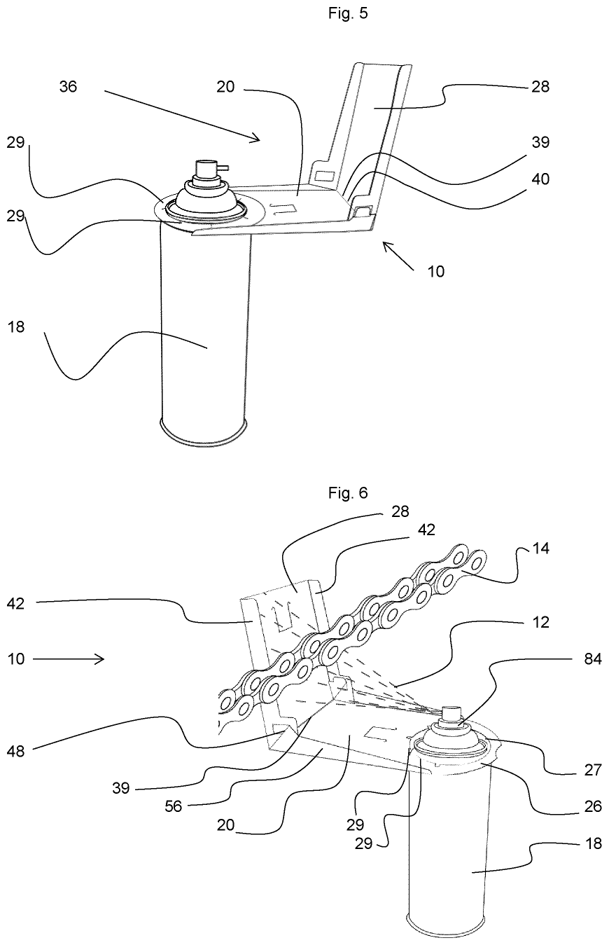

FIG. 3 shows a plan view of the first embodiment of the spray guard 10. As illustrated, the backsplash 28, the catchment tray 20, and the mounting means 26 are constructed of a continuous piece a semi-pliant material. In the first embodiment, the hinge 39 is a living hinge 40. A flexing axis 40 is located at the line of contiguity between the backsplash 28 and the distal end of the catchment tray 22, which forms the living hinge 39 therebetween. Both the flexing axis 40 and the hinge 39 are labelled in FIG. 5, though the point to essentially the same position.

FIG. 2 shows the first embodiment of the spray guard 10 in the storage position indicated by arrow 34 secured to an aerosol dispenser 18. FIG. 6 provides greater detail of the spray guard in the storage position 34. Here the catchment tray 20 and the backsplash 28 are folded about the living hinge 40 to lie against one another with their respective longitudinal axes in alignment. The backsplash 28 and the catchment tray 28 are reversibly warpable to curve about their longitudinal axes to wrappingly accommodate the curvature of the aerosol dispenser. In this manner the spray guard 10 can be shaped to curve and wrap around the aerosol dispenser 18 in the storage position 34. The spray guard 10 can be secured to the aerosol dispenser 18 using a fastener 38 such as an elastic band if desired. Alternatively, a heat shrink material could be applied over the spray guard and aerosol dispenser.

The backsplash 28 and the catchment tray 20 are constructed from a semi-pliant material selected from the group consisting of: polyethylene terephthalate, polypropylene, polyethylene, acrylic, polycarbonate, acrylonitrile butadiene styrene, polyvinylchloride, flexible plastic, urethane, rubber, and cardboard. The selection of a particular semi-pliant material can be made by weighing the following factors: manufacturing cost, durability, flexibility, weight, and non-reactiveness upon exposure to the particular aerosol fluid being dispensed.

In order to move the spray guard 10 from the storage position 34 to the in-use position 36 shown in FIG. 4, the backsplash 28 and the catchment tray 20 are pivoted apart about the living hinge 40 and moved into a position in which the backsplash 28 extends substantially perpendicular to the longitudinal axis of the catchment tray 20. The first embodiment of the spray guard

The first embodiment of the spray guard 10, in which the backsplash 28, the catchment tray 20, and the mounting means 26 are constructed of a continuous piece of a semi-pliant material is advantageous. The entire spray guard can be stamped, die cut or laser cut, from a sheet of flexible plastic as a single blank.

In the first embodiment, the mounting means 26 comprises a specially configured mounting hole 27, the perimeter of which is defined by the catchment tray 20 at a position adjacent the proximal end 22 thereof. The hole 27 is sized to receive a portion of an aerosol dispenser 18 at a position adjacent its dispensing nozzle 84. Other configurations are possible to accommodate different types of aerosol dispensers. If the aerosol dispenser 18 is an aerosol can, as shown in the attached drawings, the mounting hole 27 will be based upon a circular shape. The perimeter of the mounting hole 27 may define independent mounting tabs 29 projecting toward the centre thereof. When the mounting tabs 29 come into contact with the aerosol can, they will flex to ensure a firm fit onto the rim of the can. In this manner, the mounting hole 27 can be made to fit 2-3 can sizes. Standard common metal aerosol cans are either called necked or straight walled. The mounting tabs 29 fix and create pressure on the metal rim of the aerosol can to keep the unit and firmly on the can. The mounting tabs 29 bend to fit the can diameter and create pressure to hold the spray guard 10 firmly to the aerosol dispenser 18.

Additional features of the spray guard 10 can be provided simply by adjusting the template for the spray guard to alter is shape, to cut thinned portions or perforations. For example, the living hinge 39 is formed by a linear portion where the blank is thinner than the surrounding material creating a flex zone defining a flex axis 40 about which the surrounding portions may pivot.

Support anchors 48 are provided to maintain the spray guard 10 in its in-use position and to provide increased overall structural stability. As shown in FIG. 3, the catchment tray 20 is cut wider adjacent its distal end 24 to form a pair of tabs 50 which project from the sides of the catchment tray. The backsplash 28 is cut wider adjacent its proximal end to form a pair of receiving slots 52 into which may be fitted the pair of tabs 50. Short lateral cut lines 54 are provided on either side of the spray guard at positions aligned with the flex axis 40. When the pair of tabs 50 are received in the pair of slots 52 the spray guard 10 holds its in-use position (shown generally by arrow 36) with the backslash 28 extending substantially perpendicular to the longitudinal axis of the catchment tray 20.

As seen in FIG. 4, the spray guard 10 may further comprise a side guard panel 42 extending from a first side 44 of the backsplash 28. A second side guard panel may also extend from a second side 46 of the backsplash 28. The side guard panels 42, 42 are formed by cutting scored lines 49, 49 at a selected position adjacent to the side 44 and the side 46 of the backsplash at its proximal end. Each side guard panel 42 may then be folded and pivoted along scored line 49 relative to the backsplash 20. The catchment tray 20 further comprises a raised rim 56. The raised rim 56 is provided along a first side 58 and a second side 60 of the catchment tray 20. The raised rim 56 is formed by cutting a scored line 62 at a selected position adjacent to the first side 58 and the second side 60 of the backsplash 20. The portions outside the scored line 62 are folded and pivoted along the scored line 62 to form the raised rim 56. The presence of a raised rim 56 allows the catchment tray to retain drops of aerosol liquid which may fall while an article is being sprayed.

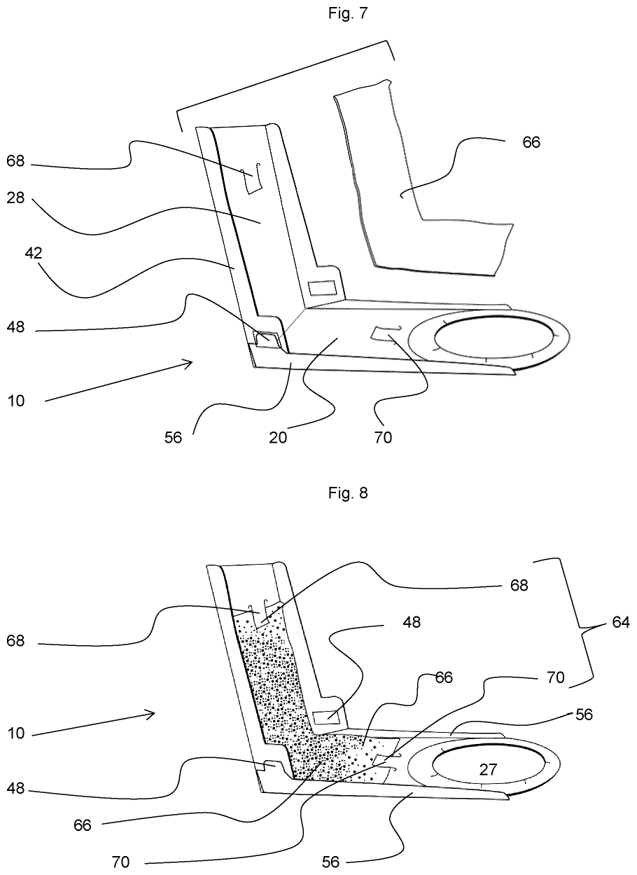

As best seen in FIG. 7 and FIG. 8, the spray guard may further comprise a retaining means 64 for removably supporting a disposable absorbent member 66. By way of example, in the illustrated embodiment the retaining means 64 comprises a first retaining tab 68 positioned on the distal end 32 of the backsplash 28 and a second retaining tab 70 positioned on the proximal end 22 of the catchment tray 20. An absorbent member 66, such as a paper towel or piece of cloth can be frictionally held under each of the first retaining tab 68 and the second retaining tab 70. In use, the overspray is then captured by the absorbent member 66, which can be discarded after use. The retaining tabs 68, 70 prevent the absorbent member 66 from moving under direct contact with a pressurized spray stream. This enables the absorbent member 66 to capture most of the overspray instead of fouling the spray guard 10. This eliminates the need for a user to repeatedly clean the backslash 28 and the catchment tray 20 after every use.

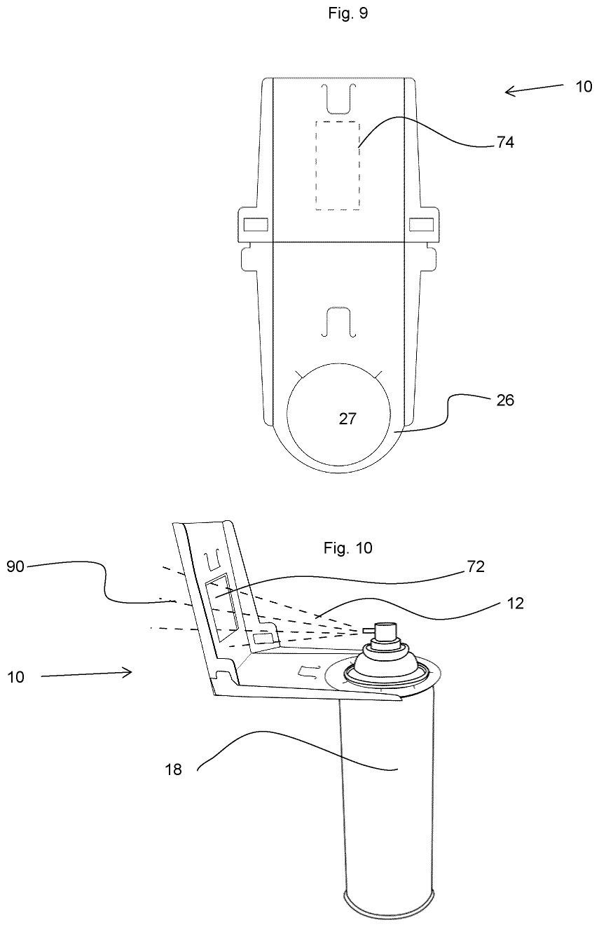

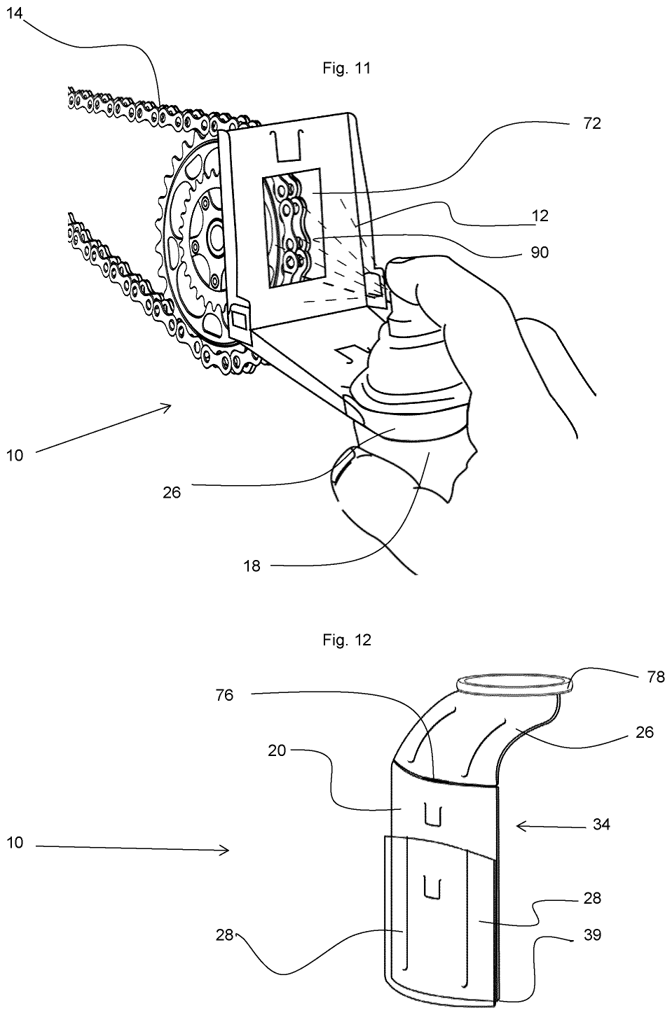

FIG. 9, FIG. 10 and FIG. 11, illustrate a second embodiment of the spray guard 10 according to the present invention. In this embodiment, the backsplash 28 defines an opening 72 therethrough of a selected shape and size to permit a portion 90 of an aerosol spray 12 to pass through the backsplash 28 in a focused spray. In instances where the backsplash 28 is formed from a sheet of semi-pliant material, the opening 72 can be formed by a perforated line 74 defining the boundaries of the opening 72. If desired, a user can then punch out the area defined by the boundaries to create the opening 72. In embodiments where the backsplash is formed of a rigid material the opening 72 will created as the backsplash is molded. This embodiment of the spray guard 10 is useful for focusing an aerosol spray to target an item that is fairly narrow from side to side but is long or continuous. As illustrated in FIG. 11, a spray guard 10 having an opening 72 can be used to focus an aerosol spray to spray lubricate a bicycle or motor cycle without spraying other components.

As introduced above, the catchment tray and the backsplash, together are configured for being moveable between a storage position shaped to wrappingly accommodate a curvature of the aerosol dispenser, and an in-use position wherein the backsplash extends substantially perpendicular to the longitudinal axis of the catchment tray. The first and second embodiments of the invention accomplished this feature because they are constructed from a semi-pliant material. The backsplash and the catchment tray are reversibly warpable to curve about their longitudinal axes to wrappingly accommodate the curvature of the aerosol dispenser.

The spray guard 10 according to the first embodiment of the present invention is easy and convenient to use. The spray guard 10 will typically be in the storage position 34 when a user receives it. In order to move the spray guard 10 from the storage position 34 to the in-use position 36 the user will first fold each of the side guard panels 42, 42 along scored lines 49, 49 located adjacent to the first side 44 and the second side 46 of the backsplash 28 toward the longitudinal axis of the backsplash 28, deploying the side guard panels 42. The user then folds each of the edges adjacent to the first side 58 and the second side 60 of the catchment tray 20 along scored lines 62, 62. They are folded inwardly toward the longitudinal axis of the catchment tray, thus creating raised rim 56 on the catchment tray 20. The backsplash 28 and the catchment tray 20 are then pivoted toward one another about the hinge 39 bringing the spray guard 10 into the in-use position 36 in which the backsplash 28 extends substantially perpendicular to the longitudinal axis of the catchment tray 20. The support anchors 48 located on either side of the spray guard 10 adjacent to hinge 39 can then be engaged by inserting the respective tab 50 on the catchment tray into the slot 52 on the backsplash 28. Once in the in-use position 36, the spray guard is then placed onto the aerosol dispenser 18 at a position adjacent to the spray nozzle 84 with the spray nozzle extending upwardly through the mounting hole 27 in mounting means 26. The mounting means 26 is then urged downwardly onto the aerosol dispenser 18 bending the mounting tabs 29 as needed to accommodate the diameter of the aerosol dispenser. The mounting tabs 29 will be secured against the ridges on the aerosol dispenser 18. The aerosol dispenser 18 and spray guard 10 are then ready for use and the aerosol dispenser is then positioned with the target item to be sprayed in between the backsplash 28 and the nozzle 84 of the aerosol dispenser. This positioning is best seen in FIG. 1 which shows the spray guard 10 being used to spray lubricant onto a motorcycle chain 14. As the aerosol dispenser 18 is actuated, an aerosol spray 12 is directed toward the chain 14. That portion of the aerosol spray 12 which does not hit the chain 14, i.e. the overspray, is captured by the backsplash 28 and the side guard panels 42, 42. The catchment tray 20 will also capture overspray and can additionally capture any excess lubricant which drips down from the chain 14. Once use has been completed, the spray guard 10 can be removed from the aerosol dispenser 18 and cleaned using a solvent or soap and water. In order to reduce the need for clean up after use, an absorbent member 66 such as a cloth or paper towel can be placed onto the spray guard 10 overlaying the backslash 28 and the catchment tray 20 and secured by behind the first retaining tab 68 and the second retaining tab 70 of the retaining means 64. The aerosol dispenser is then positioned and used as before, but the overspray will be captured by the absorbent member 66 rather than by the backsplash and the catchment tray. Once spraying is complete, the soiled absorbent member 66 is removed from the spray guard 10 and discarded.

In order to spray or lubricate small or awkwardly positioned target items, such as spraying the back of a motor cycle chain as shown in FIG. 11, the spray guard 10 can be used in its second embodiment, as shown in detail in FIG. 9-10. The user will punch out the portion of the backsplash inside the perforated line 74, thereby creating the window 72. The spray guard 10 is mounted to the aerosol dispenser 18 as discussed above and then the dispenser is positioned so that the backsplash 28 is in front of, not behind the target item. The spray dispenser 18 is actuated to produce an aerosol spray 12 directed toward the backsplash 28. A portion 90 of the aerosol spray 12 will pass through the window 72, being focused onto the target item. The wider portions of the aerosol spray 12 will be captured by the backsplash 28, the side guard panels 42 and the catchment tray 20.

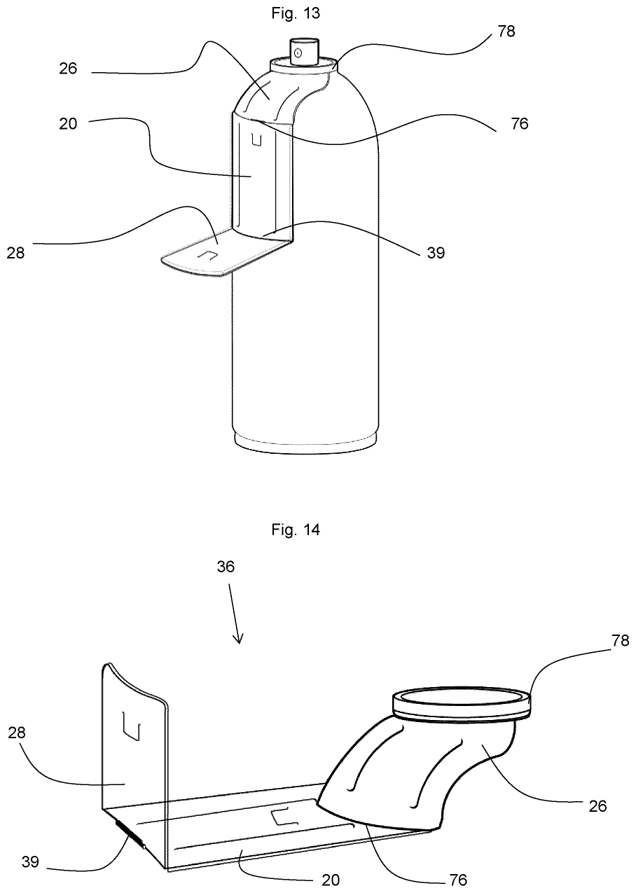

The third embodiment of the invention illustrated in FIG. 12-FIG. 16 is directed to a spray guard 10 having the containment tray 20 and a backsplash 28 constructed of substantially more rigid material. Suitable materials include polypropylene, nylon and polyethylene. In the third embodiment, the backsplash 28 is curved about its longitudinal axis 25 to wrappingly accommodate the curvature of the aerosol dispenser 18. The curved shape can be pre-molded or shaped during manufacturing to have the same curvature as an aerosol can. The curved shape of the backsplash 28 can be seen in FIG. 14. Likewise, the catchment tray 20 is curved about its longitudinal axis 25 to wrappingly accommodate the curvature of the aerosol dispenser 18. The curved shape of the catchment tray 20 can be seen in FIG. 13. The distal end 24 of the catchment tray 20 is attached to the proximal end 30 of the backsplash 28 by a hinge 39.

The hinge 39 for use in the third embodiment may be selected from many types of hinges. A live or living hinge may be used if the material used to construct backsplash and the catchment tray can either be thinned sufficiently to provide a flexing zone 40 or can be attached to a flexible material to form a flexing zone 40. Otherwise a mechanical hinge, such as a pin hinge, a barrel hinge, snap on, or circular hinge can be used. For illustration purposes only, a mechanical hinge is shown in FIGS. 12-14.

Moreover, hinges can be placed in any location needed to wrappingly accommodate the curvature of the aerosol dispenser for storage, packaging and sale. In the third embodiment shown in FIGS. 12 to 16, the mounting means 26 is hinged to the proximal end 22 of the catchment tray 20 by a mounting hinge 76. The use of a mounting hinge 76 provides degrees of freedom to permit a substantially rigid but curved back splash 28 and a substantially rigid but curved containment tray 20 to be aligned together and aligned with respect to the aerosol dispenser 18 to permit engagement of the mounting means with the aerosol dispenser 18.

Two versions of a mounting means 26 for a spray guard according to the third embodiment are illustrated in the accompanying drawings. In the first version shown in FIG. 12 to FIG. 14 the mounting means 26 comprises a snap-on ring 78 which is sized for snap-on friction fit onto the neck of the aerosol dispenser 18 adjacent to the dispensing nozzle 84. The snap-on ring 78 can be manufactured with small locking ridges to improve the friction fit.

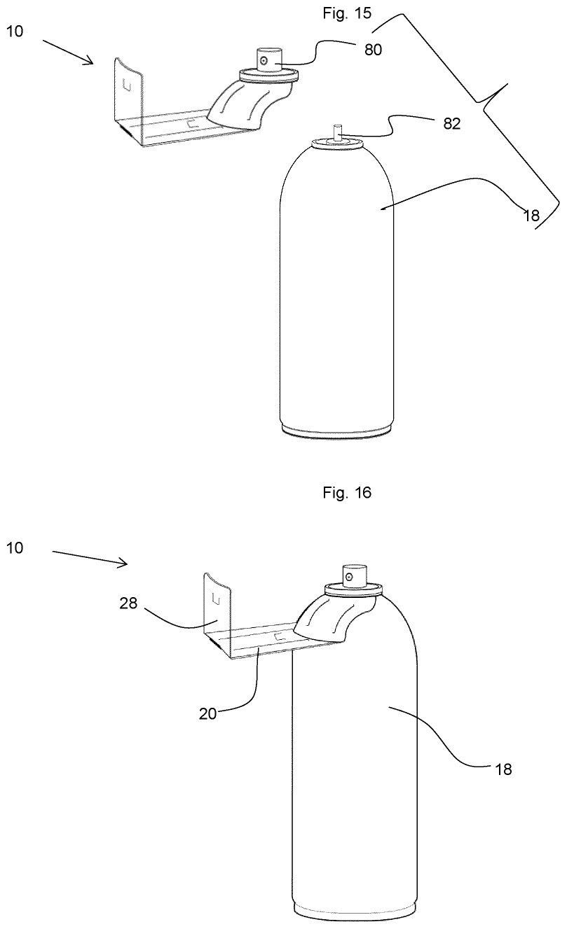

In the second version, shown in FIGS. 15 and 16, the mounting means 26 comprises an aerosol dispenser actuator 80 configured to operatively receive a stem 82 of a nozzle 84 of an aerosol dispenser 18.

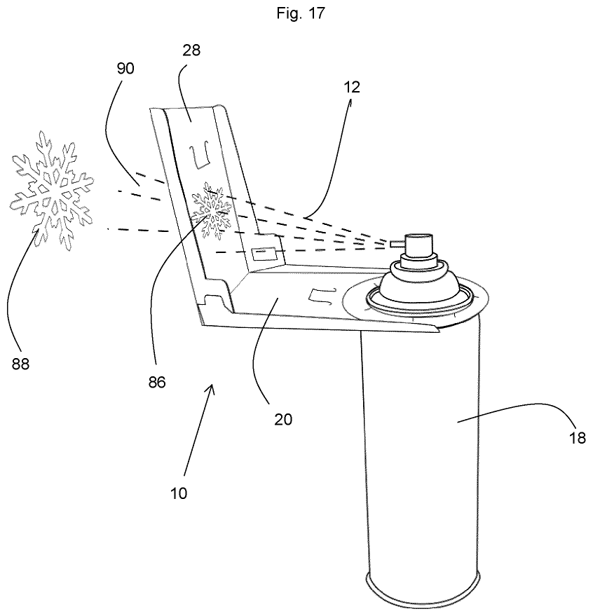

A final alternative embodiment of the present invention is illustrated in FIG. 17. In this embodiment the backsplash 28 defines a stencil opening 86 therethrough instead of merely a narrowed opening to focus the aerosol spray to a narrowed target area. The stencil opening 86 may be of any selected shape to permit a portion 90 of an aerosol spray 12 to pass through the backsplash in a focused spray to transfer an image 88 of the selected shape onto a substrate. This embodiment of the invention is a departure in the purpose of the spray guard 10, but it has many applications. In the commercial or industrial context, it can be used for uniformly marking pieces of equipment with reference numbers, target points etc., simply by selecting an appropriately shaped stencil opening 86 to mount to an aerosol paint can. For home use decorative stencil shapes, such as the snowflake shown in FIG. 17 can be formed. The decorative stencil shapes can be used with paint, chalk paint, artificial snow, spray on glitter, spray on glue for attaching glitter, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A spray guard mountable to an aerosol dispenser, the spray guard comprising:
a catchment tray having a proximal end and a distal end and defining a longitudinal axis;
a mounting means positioned adjacent to the proximal end of the catchment tray; and,
a backsplash having a proximal end and a distal end and defining a longitudinal axis, said proximal end of the backsplash being contiguous with the distal end of the catchment tray;
said backsplash being hinged to the distal end of the catchment tray;
the catchment tray and the backsplash, together, configured for being moveable between a storage position shaped to wrappingly accommodate a curvature of the aerosol dispenser, and an in-use position wherein the backsplash extends substantially perpendicular to the longitudinal axis of the catchment tray.

2. (canceled)

3. The spray guard of claim 1, wherein the mounting means is hinged to the proximal end of the catchment tray.

4. The spray guard of claim 1, wherein the backsplash is curved about its longitudinal axis to wrappingly accommodate the curvature of the aerosol dispenser; the catchment tray is curved about its longitudinal axis to wrappingly accommodate the curvature of the aerosol dispenser; and the distal end of the catchment tray is attached to the proximal end of the backsplash by a hinge.

5. The spray guard of claim 1, wherein the backsplash, the catchment tray, and the mounting means are constructed of a continuous piece of a semi-pliant material defining a flexing axis between the backsplash and the catchment tray and forming a living hinge therebetween.

6. The spray guard of claim 5, wherein the backsplash and the catchment tray are reversibly warpable to curve about their longitudinal axes to wrappingly accommodate the curvature of the aerosol dispenser.

7. The spray guard of claim 5, wherein the backsplash and the catchment tray are constructed from the semi-pliant material selected from the group consisting of: polyethylene terephthalate, polypropylene, polyethylene, acrylic, polycarbonate, acrylonitrile butadiene styrene, rubber, and cardboard.

8. The spray guard of claim 1, further comprising a side guard panel extending from a first side of the backsplash.

9. The spray guard of claim 1, wherein the catchment tray further comprises a raised rim.

10. The spray guard of claim 1, further comprising a retaining means for removably supporting a disposable absorbent member.

11. The spray guard of claim 10, wherein the retaining means comprises a first retaining tab positioned on a the distal end of the backsplash and a second retaining tab positioned on the proximal end of the catchment tray.

12. The spray guard of claim 1 wherein the backsplash defines an opening therethrough of a selected shape and size to permit a portion of an aerosol to pass through the backsplash in a focused spray.

13. The spray guard of claim 12, wherein the backsplash defines a stencil opening therethrough of a selected shape to permit a portion of the aerosol to pass through the backsplash in the focused spray to transfer an image of the selected shape onto a substrate.

14. The spray guard of claim 1, wherein the mounting means comprises a collar configured to substantially encircle the body of the aerosol dispenser at a position proximal to a dispensing nozzle thereof.

15. The spray guard of claim 1, wherein the mounting means comprises an aerosol dispenser actuator configured to operatively receive a stem of a nozzle of the aerosol dispenser.
